(19) United States
(12) Patent Application Publication
(10) Pub. No.: US 2008/0202862 A1
(43) Pub. Date: Aug. 28, 2008

(54) Signal Strip And System For Determining A Movement Status Of A Moving Body

(76) Inventors: Frank Dudde, Stuttgart (DE); Wolfgang Meissner, Neuhausen (DE); Gerhard Thumm, Filderstadt (DE)

Correspondence Address: LATHROP & GAGE LC, 4845 PEARL EAST CIRCLE, SUITE 300, BOULDER, CO, 80301, US

(21) Appl. No.: 11/572,791

(22) PCT Filed: Jul. 27, 2004
(86) PCT No.: PCT/EP2005/007246

§ 371 Date: Jan. 30, 2008

(30) Foreign Application Priority Data
Jul. 27, 2004 (DE) 10 2004 037 486.4

(51) Int. Cl. G01B 7/02; B66B 3/00

(52) U.S. Cl. 187/393; 33/706

(57) ABSTRACT

The invention relates to an oblong signal strip (1), comprising signalling sections (2, 3) along the longitudinal extent thereof, each comprising at least two different pieces of information, referring to an optical property, a magnetic property or a property relating to a reflection of electromagnetic waves from the signalling section (2, 3), as determined by at least one sensor device (7-9). Information relating to the same property in alternating signal sections (2, 3) are different from each other. The signal strip (1) is applied to a system for determining a movement status of a moving body, in particular, a car (6) of a lift system (4).

The invention relates to a longitudinally extending signal strip comprising a plurality of signal sections along its longitudinal extent, and a system comprising such a signal strip for determining a movement status of a moving body.

With a plurality of moving bodies, for example material movement means in the field of automation or conveyor technology, or in the form of elevators or the like, a determination or surveillance of the speed of the moving bodies is of critical importance in order to ensure an efficient working process and also the safety of people.

With moving bodies in the form of elevator cars a mechanical safety system has proved itself for decades in which in addition to the usual carrying rope a further rope, which is guided with a pulley or with a plurality of pulleys, is attached to the moving parts, e.g. the elevator car.

Such a system is described e.g. in DE 299 12 544 U1 in the form of a centrifugal force limiter. At a predetermined excess speed of the elevator car of e.g. 20% a centrifugal force is triggered at a pulley, for example, which sets the pulley in a locked condition and hence triggers a clasp brake. Such a known single stage mechanical speed limiter however dates from the pioneer time of elevator technology and has a few disadvantages. These disadvantages arise from an increased installation space due to the provision of the additional pulley(s) and the additional rope which altogether increases the construction complexity of the elevator system. Furthermore, because of the entrained safety rope and the rotating pulley this known system creates considerable noise and is therefore only suitable for limited speeds of the car. Finally, such a system is high maintenance, in case of a failure only triggers after a certain delay, works only unsatisfactorily particularly with soiling, ageing and bad maintenance, and is in some cases unaesthetic.

Further safety systems for elevators are described in WO 00/37348 where, instead of a separate safety rope which is entrained with the moving elevator, magnetic safety or braking devices are provided. Such systems have however the disadvantage that the safety of the elevator rests on the magnetic effect alone. In choosing this physical effect no additional safety of the moving elevator is ensured.

Irrespective of safety systems for elevators and suchlike DE 203 11 861 U1 describes a device for position and/or length determination comprising a carrier unit having an absolute magnetic lengthwise or longitudinal coding and a measuring unit working together with the carrier unit. The measuring unit moves relative to the carrier unit and comprises a magnetic sensor unit which is connected with a downstream electronic evaluation unit. The longitudinally extending carrier unit is provided with the lengthwise coding in a line, wherein along the lengthwise coding a plurality of coding sections with a regular pole spacing are provided. The position and/or length determination of the measuring unit relative to the carrier unit rests solely upon the determination of a respective polarity of corresponding coding sections on the carrier unit by the measuring unit which is moving relatively thereto. Expressed another way, the position and/or length determination is based only on the magnetic effect of the carrier unit. With a failure of the measuring principle, relying on this effect, a reliable position and/or length determination can no longer be ensured.

DE 197 32 713 A1 describes a device and a process for position determination, the device or process also being based on the magnetic effect. The device comprises a measuring head having a transducer, and a transmitter being moved relative to the measuring head. The transmitter is formed as a longitudinally extending element made with a magnetised material. Parallel magnetised tracks are provided in the direction of extension of the value giver which have a periodic magnetisation corresponding to a pole division regularly spaced along the direction of extension. Therefore this device also has the disadvantage that the determination of the position of the measuring head relative to the transmitter relies solely upon the magnetic effect.

Accordingly, the problem underlying the invention is to provide a signal strip and a system for determining a position and a movement status of a moving body by which, with simple construction means, a substantially increased operational reliability is ensured.

According to the invention the problem is solved by a signal strip with the features of claim 1, by a system for determining a movement status of a moving body with the features of claim 19 and by a device for limiting the speed of a moving body with the features of claim 29. Advantageous embodiments of the invention can be found in the dependent claims.

The longitudinally extending signal strip according to the invention comprises signal sections along its longitudinal extent, wherein at least every other signal section contains respectively at least two different forms of information which are each based on a physical effect and are determinable by at least one sensor device. The respective signal sections can respectively also contain at least three information forms which are respectively based on a corresponding physical effect of the signal section. Irrespective of the number of information forms in a respective signal section this information can be respectively read with a suitable sensor device which can consist of at least one measuring element for determining one form of information of the signal strip and an evaluation circuit, whereby the measuring principle of the measuring element is adapted to the respective physical effect of the signal section.

In the case that the information forms are contained in respective consecutive signal sections, the information forms which are based on the same physical effect in alternating signal sections are respectively different from each other.

In an advantageous embodiment of the invention the information which is based on the same physical effect in every other signal section can match. Expressed another way, the information is identical in every second signal section respectively. Expediently, either all the signal sections, or the signal sections with a respective matching physical effect, can have substantially the same width in the direction of longitudinal extension of the signal strip. Through this, an even distribution of information on the signal strip with even alternating succession is ensured. Alternatively to this, it is also possible that the signal sections with different physical effects have different dimensions.

In an advantageous embodiment of the invention the physical effect can be based on a radiation which is emitted by a respective signal section. For this the signal section can be provided with an active transponder strip, an inductor, a radio transmitter, light diodes or the like, which emit the radiation respectively. The radiation can produce an electric field, a magnetic field and/or an electromagnetic field. By means of a suitable sensor device such a field can be accordingly detected, whereby conclusions can be drawn about the respective information of the signal section.

In an advantageous embodiment of the invention the physical effect can also be based on a physical property of a respective signal section. This physical property of a respective signal section can be an optical property, a magnetic property, a thermal conductivity, a property relating to a reflection of electromagnetic waves or such like.

In an advantageous embodiment, the signal sections can be alternatingly optically distinguishable from each other. Such a differentiation can be achieved using a suitable finish with contrasting colours, e.g. in the colours black and white or the like. Alternatively, the optical property of a respective signal section can relate to special optically determinable structures such as e.g. hatching, reflection, different colours or the like.

In an advantageous embodiment the signal sections can respectively have an alternatingly different magnetic polarization. A number of signal sections can have e.g. a magnetic south polarisation, wherein respective signal sections arranged therebetween can have a magnetic north polarization accordingly. Such an alternating polarisation can be achieved for example through casting of a suitable metal. Alternatively to that, it is equally possible to apply a magnetic layer onto a substrate.

In an advantageous embodiment of the invention at least one signal section of a pair of adjacent signal sections with alternating different information can be respectively provided with a material which reflects electromagnetic waves differently. This reflection property can relate e.g. to electromagnetic waves with a wave length in the ultrasonic and/or the radar range. This physical property relating to the reflection of electromagnetic waves can be achieved through a coating with a certain metal, wherein it should be ensured that such a metal does not negatively interfere with the previously explained magnetic effect of a corresponding signal section.

Relating to the above mentioned physical property it can suffice that only every second signal section respectively is provided with a coating of the said material, or that two adjacent signal sections are differently coated, in order to achieve the desired reflection properties relating to electromagnetic waves. Alternatively, it is equally possible to coat alternating signal sections respectively with different metals which reflect corresponding electromagnetic waves, e.g. in the ultrasonic and/or radar range, differently. Any other non-metallic material can be used for this purpose as long as it ensures the above mentioned effect. In addition to a coating, it is also possible to arrange the said metal in a corresponding signal section next to further areas each having different physical effects.

In an advantageous embodiment of the invention the signal sections can alternatingly have respective different thermal conductivity and/or different temperature. In particular for a different thermal conductivity of adjacent signal sections, these signal sections can be respectively set to a different temperature which is detectable by a suitable sensor device.

The main advantage of the signal strip according to the invention over conventionally known magnetised carrier materials is that the single signal sections of the signal strip contain at least two different information forms which are each based on different physical effects. These physical effects can be detected with suitable sensor devices which are accordingly based on different physical measurement methods or principles. For a plurality of sensor devices, the measurement principles of the individual sensor devices are different and do not influence each other. A failure of a sensor device or a determination of a physical effect of a signal section of the signal strip has no effect at all on the other sensor devices or the determination of a or the further physical effects of a respective signal section of the signal strip. If, for example, a large amount of smoke is created in the area of the signal strip following a fire, such that the optical property of the respective signal section can no longer be determined by an optical sensor device, despite these conditions a determination of the north or south polarisation and/or a determination of a reflection property of the signal section with electromagnetic waves or of a further physical, however not optical, effect is still possible. With a failure of a measurement principle because of outside influences a determination of a further physical effect or of two further physical effects of a respective signal section of the signal strip can still be carried out with the further sensor devices. Through this, the functioning safety together with the position determination of a moving body is considerably increased.

Each signal section can comprise material layers lying on top of each other which each have a different physical property. Similarly, it is however also possible to provide in a respective signal section material sections arranged next or adjacent to each other which account for the respective physical property. In a further modification to this, it is possible in a respective signal section to arrange two material sections with different physical properties next to each other, and to arrange a further material layer with a different physical property over or under them.

In an advantageous embodiment of the invention a protective coating or the like can be applied to a surface of the signal strip, the protective coating being abrasion-resistant, scratch proof and/or oil repelling. Such a protective coating ensures that, for every use of the signal strip in rough exterior conditions, the physical effects or properties of the signal strip, in particular the optical property and the property relating to a reflection of the electromagnetic waves, are not affected by a possible damage to the signal strip.

The above described signal strip is suitable, in particular, for a system according to the invention for determining a movement state of a moving body. Such a system comprises furthermore, complementary to the at least two information forms of each signal section of the signal strip, at least two sensor devices. The sensor devices comprise respectively at least a measuring element for determination of one of the information forms of the signal strip, and an evaluation circuit. A measurement principle of a respective measuring element is suited to or adapted to a physical effect of a respective signal section, the measurement principle of the sensor devices being different from each other. At this, either the signal strip or the sensor devices can be fitted to the moving body, so that as a result of a movement of the body the signal strip and the sensor device are movable relative to each other.

Furthermore, the system comprises a control unit, wherein the evaluation circuit of a respective sensor device relating to a respective physical effect of a signal section produces an electrical signal and outputs it to the control unit. The control device is designed so that, based on the electrical signals of the sensor devices, a speed, a movement direction and/or a current position of the body relative to the signal strip or to the sensor devices can be determined. The sensor devices can be fitted to the moving body, with the signal strip being arranged to be stationary e.g. in an elevator shaft, so that the body is movable adjacent and relative to the signal strip. Alternatively to this, the signal strip can also be fitted to the body, with the sensor devices being arranged stationary e.g. in an elevator shaft or the like. Accordingly, the body is movable adjacent and relative to the sensor devices.

In adaptation to a signal strip in which each respective signal section contains three information forms, the system according to an advantageous embodiment of the invention can comprise a further sensor device. The further sensor device has, similarly, at least one measuring element for determination of one of the information forms of the signal strip, and an evaluation circuit, with the measurement principle of the measuring element of this further sensor device being suited or adapted to one of the physical effects of a signal section, and the measurement principles of the individual sensor devices are different from each other. The further sensor device produces an electrical signal in response to a respective effect of a signal section, and outputs this signal to the control unit of the system. Such a system therefore has altogether three sensor devices which, regarding their measurement principles, are appropriately matched to a respective physical effect of the signal strip. This system has the advantage that a movement of the body relative to the signal strip or relative to the sensor devices can be determined on the basis of three different measurement principles, whereby the operational reliability or safety of the system is increased.

Irrespective of the number of sensor devices, another important advantage of the invention lies in the fact that the physical effects or properties of the signal strip can be determined without contact, whereby a lower wear and a corresponding long service life of the signal strip is ensured.

In an advantageous embodiment of the invention, the electrical signal which is produced by the evaluation circuit of a corresponding sensor device can be a square wave signal. At this, the evaluation circuit is programmed in such a way that the frequency of the outputted electrical signal is directly proportional to the speed of the moving body. Alternatively to this, the frequency of the outputted electrical signal can also be inversely proportional to the speed of the moving body. Furthermore, the respective sensor devices are designed so that, in an abnormal working condition relating to the signal strip, the associated evaluation device produces an electrical signal with a parasitic frequency. An abnormal working condition can arise through e.g. a missing signal strip resulting in an absence of a determination of a respective physical effect, through disturbing dirt on the signal strip which in particular negatively affects the optical property, through a signal strip with a wrong code, through insufficient or excess voltage of a sensor device, through an excessive speed of the body or the like. Therefore, with the system according to the invention, it is not only possible to determine a position or a speed of the body relative to the signal strip or the sensor devices, but an unacceptably big gap of a respective sensor device in relation to the signal strip can also be detected. Following this, suitable safety measures can be introduced, e.g. a stopping of the body either directly after the appearance of an electrical signal with a parasitic frequency, or alternatively at a predetermined position.

In an advantageous embodiment of the invention, the system can have at most one sensor device which is based on the optical measurement method. With more than three sensor devices it is appropriate to also provide more than one optical sensor. A determination of a corresponding optical property of the signal strip based on the optical measurement principle has, due to the sensitivity regarding an obstructed view in the form of steam, smoke or the like, the advantage that a fire developing in an area of the moving body can be easily detected. Nevertheless it is sufficient with regard to the detection of a possible developing fire or the like that one at the most of the sensor devices is based on the optical principle. In order to satisfy the advantageous diversity of the sensor devices, the other sensor devices can in this case be designed as a magnetic sensor and a sensor for registering a reflection of electromagnetic waves.

In an advantageous embodiment of the invention the control device can comprise a plurality of channels, the sensor devices each producing at least one electrical signal which are fed into the channels of the control device. To comply with safety regulations relating to breakdown avoidance which apply to some applications, particularly elevator devices or the like, the individual channels can be different from each other regarding their hardware and/or software. Expressed differently, different processors for example are used with different channels, whereby the probability of a failure of the processors at the same time is considerably reduced. The certainty of the position and/or speed measurement of the moving body can be furthermore increased in that the individual channels are continually calibrated with each other.

With the system according to the inventions, which can include a signal strip having three different physical information forms in each signal section and three corresponding sensor units each with different measuring principles, a very reliable measurement of the position and/or speed of the moving body can be carried out when each of the sensor devices respectively feeds at least one output signal to each channel of the control device. This safety aspect of the system satisfies the “2 out of 3” principle, according to which each of the three sensor devices feeds two output signals to the respective channels of the control device. The electrical signals of the respective sensor device can either be based on the same physical measurement principle or can be based on two different physical measurement principles. In the latter case the sensor device has at least one measuring element based on the optical principle in order to take account of the seriousness of a possible detection of fires or a development of smoke, which is in particular possible with this principle.

According to the invention a device for the speed limitation of a moving body is furthermore provided, the device comprising a signal strip and a system as described above. The device comprises furthermore a brake device and/or a gripping device which can act respectively upon the moving body, the control device being electrically connected with the brake device and the gripping device and being designed such that in determining a speed of the body which exceeds a first predetermined threshold, a first electrical control signal is output, upon which the brake device acting on the body is activated. Furthermore, a second electrical signal is output by the control device with a determination of a speed of the body which exceeds a second predetermined threshold, whereby the gripping device acting on the body is activated, which thereupon directly stops the body. Such a device for the speed limitation of a moving body is advantageously suited for use in elevator devices in order to monitor the speed of the elevator and to limit it if necessary. Compared to the above mentioned conventional mechanical safety system for elevator systems, the device according to the invention is advantageous for use in elevator systems with a small installation space, because no installations in a head space or in a base or bottom area of the elevator shaft are necessary. It is also advantageous because of a time saving and simple assembly e.g. of the signal strip and the sensor devices and also because of a low noise operation due to the contact free sensing of the signal strip.

For use in elevator systems or the like, in order to satisfy the safety criteria of the so-called elevator directive or regulation, the device according to the invention can have in an advantageous embodiment at least one safety relay device which is connected between the control device and the brake device or the gripping device, the electrical control signals of the control device being fed to the safety relay device. For a further increase in the safety standard the safety relay device can comprise at least a first safety relay and a second safety relay which are expediently powered by separate circuits respectively separated from each other. The first control signal of the control device is hence fed to the first safety relay and the second control signal of the control device is fed to the second safety relay. In the case that the control device, because of an error in the movement of the body e.g. in the form of an excessive speed or a missing signal from a respective sensor device, outputs the first electrical control signal or the second electrical control signal to the corresponding safety relay in order to brake as necessary or even to stop the body, a subsequent operation of the body is only possible after a feedback signal from the corresponding relay is sent to the respective channel of the control device. Such a feedback signal is generated for example when an operator repairs the determined fault and, in the case of a monostable relay, resets the corresponding safety relay in the working position.

In an advantageous embodiment of the invention the above mentioned gripping device can be coupled with an actuator device which is controllable by the second electrical control signal. By feeding the second electrical control signal to the actuator device the gripping device is actuated by the actuator device so that following this, the moving body or the car of the elevator system is stopped by the gripping device. The gripping device can consist for example of a conventionally known wedge device which arrests f the moving body, in particular in the form of an elevator car, in usual way. Such a gripping or catch device has been well known for several decades in the field of elevator systems and is therefore not further described here.

In the case that the device has several gripping devices, expediently several actuator devices are provided, that is, one actuator device per gripping device, respectively. In an elevator system, if required two actuator devices can be provided in a downwards direction and two actuator devices can be provided in an upwards direction in order to provide a sufficiently big actuating force for the gripping device.

In an advantageous embodiment of the invention the device can comprise a signal strip with three different information forms per signal section, respectively. In accordance with this signal strip, three sensor devices can be respectively provided which are based on different measuring methods for determination of the physical effects of the signal strip. Either the signal strip or the sensor devices are fitted to the moving body. The control device of the device is designed so that with an erroneous signal from only one sensor device, or with the sending of an electrical signal with the parasitic frequency from only one sensor device, the body is not directly stopped, but stopped only after it has reached a predetermined position. At this, the control device can produce the corresponding electrical control signal for stopping the moving body. It is furthermore possible to feed a further electrical control signal to a control unit for control of a movement of the moving body in order to hence trigger the stopping of the body.

In using the device according to the invention in an elevator system, three safety stages for the drive operation of the elevator car are therefore ensured. According to a first safety stage, in case of a failure of only one of the sensor devices, i.e. upon an electrical signal with the parasitic frequency, the car continues to be moved to a following stop or the next floor in order to be subsequently stopped there for a further examination by an operator. Because of the “safety provision or reserve” of two further sensor devices, the failure of one sensor device does not immediately lead to an emergency stop of the elevator, whereby a corresponding endangerment or irritation of the occupants can be advantageously avoided.

According to a second safety stage of the device according to the invention, the first electrical control signal for activating the brake device is produced by the control device when, on the basis of the electrical signals from a sensor device or preferably from two sensor devices, a speed is determined which slightly exceeds a predetermined target speed of the elevator. By the produced first electrical control signal a safety circuit of the corresponding safety relay is interrupted, as explained above, whereby the brake device acting on the car is activated in order to suitably reduce the speed of the elevator. Expediently, the effect of the brake device on the movement of the car can be such that only slow changes in speed arise.

According to a third safety stage of the device according to the invention the second electrical control signal for activating the gripping device is produced by the control device when, on the basis of an electrical signal from a sensor device or preferably from two sensor devices, a speed of the elevator is determined which exceeds the predetermined target speed by a considerable amount, e.g. by 20%. The second electrical control signal triggers the actuator device and hence the gripping device, whereby the car is immediately stopped.

However, the triggering of the gripping device occurs only in an emergency in which the car, e.g. because of a break of the rope or the like, is in free fall, or when for other reasons an excess speed of the car arises either in the upwards or downwards direction.

According to a further safety aspect of the device, the body or the car is also stopped, irrespective of a determined speed, when an electrical signal with a parasitic frequency is given as output from two sensor devices respectively to the control device.

As explained above, a general safety aspect of the device according to the invention lies in the fact that the first electrical control signal and the second electrical control signal for activating the brake device or the gripping device are fed to respective safety relays which are separate from each other and which are powered respectively by a separate circuit. With a failure of the circuit of one safety relay a continued operation of the other safety relay is ensured.

In an advantageous embodiment of the invention, the electrical signal with the parasitic frequency from one of the sensor devices can produce a further electrical signal in the control device which is fed to a control unit for controlling a movement of the moving body. This control unit can be for example a central elevator controller which is separately connected with the first safety relay and the second safety relay. In the case that this further electrical signal is fed to the central elevator controller the central elevator controller can produce, in concordance with further information, contained in the elevator controller concerning speed and/or position of a car, a further signal for interrupting the circuit of the first safety relay, in order to slow down the car or to bring it to a predetermined position. Alternatively or additionally the central elevator controller can produce a so-called service signal, whereby service personnel are informed of the existence of an abnormal operating state.

In an advantageous development of the invention the signal strip can be fitted in a trackway of the moving body. With use in an elevator system the signal strip sticks, expediently, magnetically to a track of the car so that no separate attachment elements are necessary for the signal strip.

In the case that the signal strip is furthermore provided in its individual signal sections with a respective absolute coding, not only the speed or the direction of movement of the moving body can be determined by the system according to the invention, but also an absolute position of the body in relation to the signal strip or the sensor devices can be determined. In using such a signal strip in an elevator system the position of the car in the elevator shaft can be determined, which allows in particular the operation of several cars along the same trackway or guide rail without giving rise to a danger of collision of the cars.

Further advantages and forms of the invention can be found in the description and the accompanying drawings.

The above mentioned features and the features to be described in the following can obviously be applied not only in the respectively given combination, but also in other combinations or alone, without extending beyond the scope of the present invention.

The invention is schematically shown with one embodiment in the drawing and is described in detail in the following with reference to the drawing.

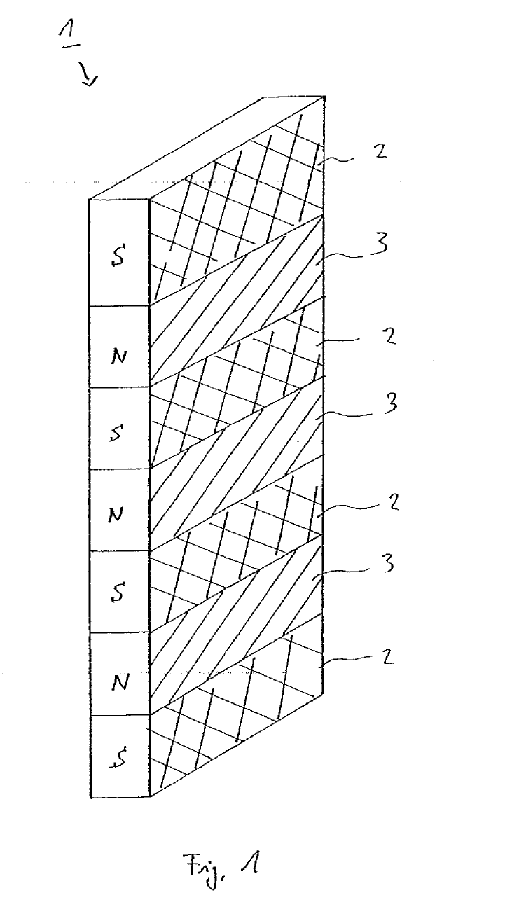

FIG. 1 shows a perspective sectional view of a signal strip according to the invention.

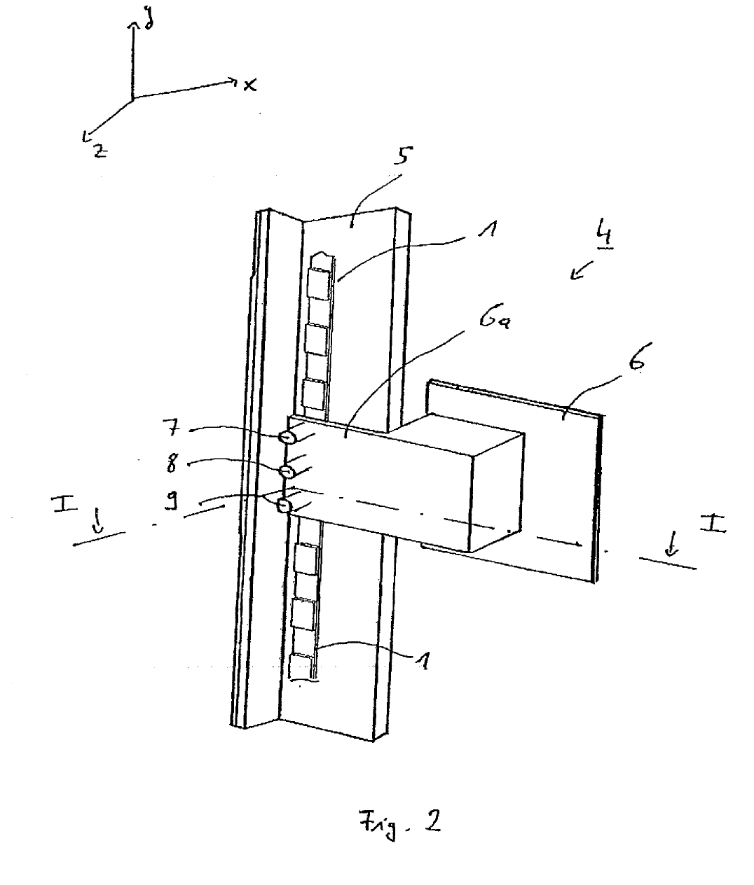

FIG. 2 shows the signal strip of FIG. 1 in use in an elevator system.

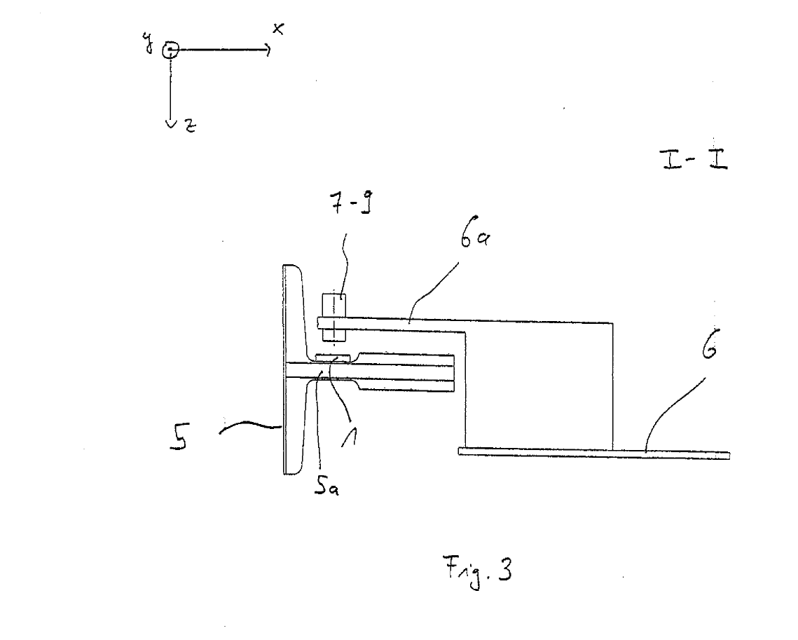

FIG. 3 shows a cross sectional view through the line I-I in FIG. 2.

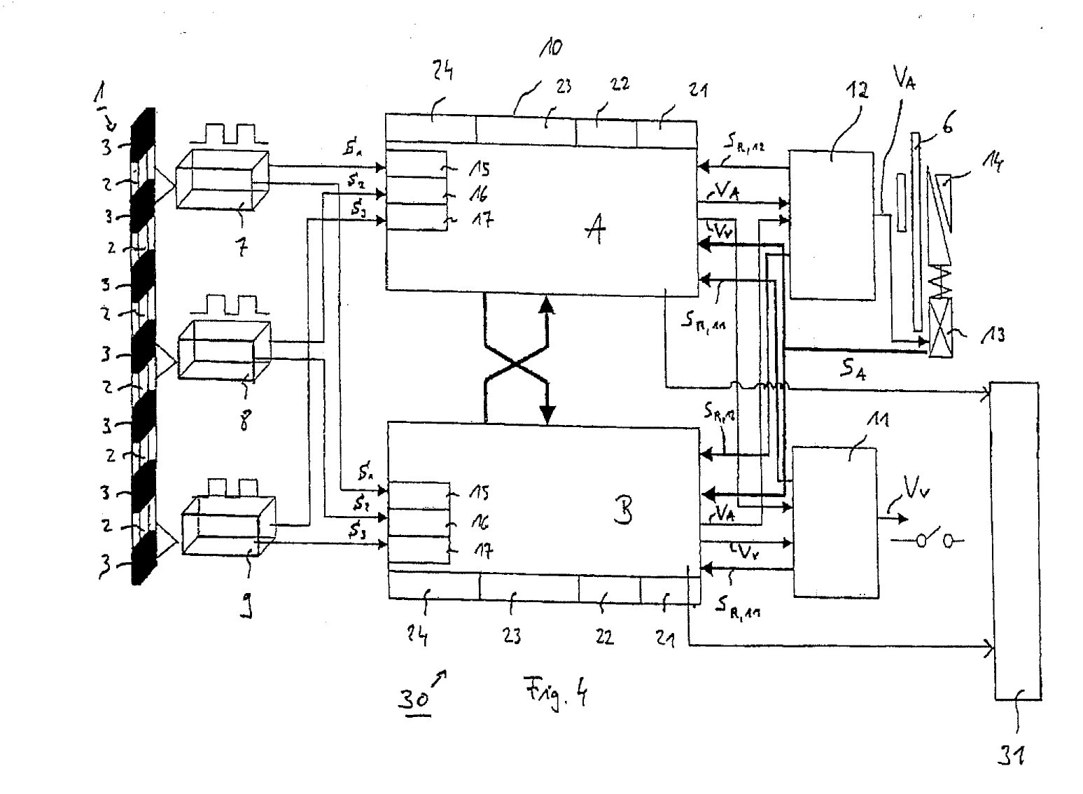

FIG. 4 shows a structure diagram of the mode of operation of a device according to the invention for limiting the speed of a moving body, the device being provided for use in the elevator system of FIG. 2.

FIG. 1 shows a signal strip 1 according to the invention in a sectional perspective view. The signal strip 1 has a longitudinal extent, with individual signal sections 2, 3 being provided along this longitudinal extent. The alternating signal sections 2, 3 contain three different information forms, respectively, which each relate to physical properties of the signal strip, that is, an optical property, a magnetic property and a property based on the reflection of electromagnetic waves. In detail, the signal sections are designed such that information forms based on the same property in alternating signal sections are respectively different from each other, as explained in the following.

In the embodiment shown in FIG. 1 every second signal section 2 is formed with a magnetic south polarization, which is identified with the letter “S”. Furthermore the signal sections 2 are covered with a layer of copper which is depicted with cross hatching. Through this copper layer, the signal sections 2 are given a certain property relating to a reflection of electromagnetic waves, for example of ultrasonic waves. Finally, the signal sections 2 are lacquered in white. Through this the signal sections 2 are given a certain optical property. In addition to copper, any other metal can also be used as a coating for the signal strip 1 as long as it does not compromise the said magnetic property.

In addition or as a modification to a coating of a respective signal section it is similarly possible to arrange the metal having a certain property relating to a reflection of electromagnetic waves, also next to regions of the signal section having a physical property different to it.

The signal sections 3, which are arranged respectively between the signal sections 2, are provided with a magnetic north polarization “N”. In contrast to the signal sections 2 the signal sections 3 are not covered with a layer of copper, so that they differentiate themselves from the signal sections 2 in relation to a reflection of ultrasonic waves or the like. Finally, the signal sections 3 are lacquered in black, whereby they are given a different optical property to the signal sections 2.

The above described different information forms of the signal strip 1 which relate to the respective physical properties can be determined by suitable sensor devices. Such sensor devices comprise a measuring element, the measuring method of which is suited to a corresponding physical property of a respective signal section of the signal strip, and an evaluation circuit which converts the determined information into a suitable electric signal.

In addition to the embodiment shown in FIG. 1 it is also possible that the individual signal sections emit a radiation by which different physical effects are produced. The radiation can produce an electrical field, a magnetic and/or an electromagnetic field. For this, appropriate technical means can be fitted to the signal sections which emit this radiation, e.g. a transponder strip, an inductor, a radio transmitter, one or more light diodes or the like. The corresponding field which is produced around a respective signal section can be detected with a suitable and matching sensor device.

The signal strip 1 according to the invention is excellently suited for determination of a position and speed of a moving body which is moved relative to a signal strip 1. In the following, the moving body is considered by way of example to be a car of an elevator system, without thereby limiting it to this use. Corresponding to the three respectively different information forms per section of the signal strip, three sensor devices are respectively fastened to the elevator car of the elevator system, which sensor devices make use of a different physical measurement principle corresponding to the different physical properties of the signal strip. Expressed differently, the measurement principles of the individual sensor devices are different from each other.

In drive operation of the elevator system, when the car with the sensor devices attached thereto moves relative to the signal strip 1, each sensor device respectively determines an information form of a corresponding signal section 2, 3 of the signal strip 1 or a change in this information. Such a change in the information is processed in the respective evaluation circuit of the sensor devices which produce a square wave signal with an individual characteristic frequency dependent on speed. The evaluation circuits are programmed such that the frequency of the produced electrical signals reduces with increasing speed of the car relative to the signal strip 1. The output frequency of the square signal can be calculated, for example, the following equation:

$$f = \frac{k}{{Z}_{0 i} + {v}_{akt}} [ Hz ]$$

where:

f is the output frequency in Hz;

Z₀ᵢ is a number characteristic of each sensor device;

vₐₖₜ is the current speed of the sensor device or of the car relative to the signal strip in m/s;

k is a proportional factor and adaptation for the elevator system.

In choosing a certain characteristic number Z₀ᵢ for each sensor device, the frequency of the output signal of a respective sensor device thus is given a certain value range, the latter allowing to trace back the corresponding sensor device.

According to the above equation the output frequency of the square signal wave is inversely proportional to the current speed of the car.

Alternatively to this, the output frequency of the square signal can however be directly proportional to the current speed of the car, that is, according to the equation:

f=k(Z₀ᵢ+vₐₖₜ) [Hz]

The factors or variables here correspond respectively to the factors or variables in the above equation with inverse proportionality.

FIG. 2 shows in a very simplified way an elevator system 4 in which a signal strip 1 is used. The signal strip 1 is attached vertically along a rail 5 of the elevator system. Preferably the signal strip 1 sticks magnetically to the rail 5 so that no additional attachment means is necessary for attaching the signal strip 1. Through an arm 6a three sensor devices 7, 8, 9 are attached to an elevator car 6, the arm 6a being suitably dimensioned such that the sensor devices 7, 8, 9, in drive operation of the elevator car, can be moved into a position opposing the signal strip 1.

In FIG. 3, the rail 5 and a part of the elevator car 6 are shown in a cross section through the line I-I of FIG. 2. The rail 5 is formed in the shape of a T-beam. The signal strip 1 sticks magnetically to a surface of a centre web 5a of the T-beam. The sensor devices 7 to 9 attached to the arm 6a are brought into a position opposing the signal strip 1 attached to the T-beam 5. During a drive operation of the elevator device, i.e. during a movement of the car in the y-direction in FIG. 2 and FIG. 3, the sensor devices 7 to 9 remain in a position opposing the signal strip 1 so that the respective information forms of the signal strip 1 can be determined by the sensor devices 7 to 9 without further ado.

The sensor devices 7 to 9 are each based, as previously described, on a different physical measurement principle, each suited or adapted to a corresponding physical property of the signal strip 1. In detail, the first sensor device 7 is designed as a magnetic sensor with which a corresponding magnetic polarization of the signal strip 1 is determinable (e.g. through the Hall effect, GMR, AMR etc.). The second sensor device 8 is designed as a sensor with which a property of the signal strip 1 relating to a reflection of electromagnetic waves is determinable. For this, the second sensor device 8 comprises a transmitter which transmits electromagnetic waves, e.g. in the form of ultrasound waves, in the direction of the signal strip 1. The second sensor device 8 correspondingly also comprises a receiver which receives the electromagnetic waves reflected from the signal strip 1 and forwards this information to a suitable evaluation circuit of the second sensor device 8. On the basis of the electromagnetic waves received by the receiver the evaluation circuit of the second sensor device 8 produces a corresponding electrical signal. Finally, the third sensor device 9 is designed as an optical sensor with which just optical properties of the signal strip 1 are determinable. In the present example the third sensor device 9 responds to a colour contrast of the signal strip 1 so that the black and white lacquering of the respective signal sections 2, 3 of the signal strip 1 are determinable by the third sensor device 9. Expressed differently, the physical effect principles and the evaluation circuits of the sensor devices are different. A possible cause of disruption that can be caused by an outside influence is therefore preferably only allowed to affect one single sensor device.

The electrical signals which are produced by the evaluation circuits of the three sensor devices 7 to 9 are fed into a control device which is designed in such a way that, on the basis of the individual signals of the three sensor devices 7 to 9, a direction of movement and/or a current position of the car 6 relative to the signal strip 1 is determinable. The signal strip 1, the individual sensor devices 7 to 9 which are attached to the car 6, and the control device are brought together in a system according to the invention which is capable of determining a movement state of the car 6. The control device can be made in the form of a so-called and from henceforth termed micro-controller which is described in more detail in the following.

The individual components of the system according to the invention in the form of the three sensor devices 7 to 9 and of the micro controller, which can be attached to the car 6 for example, are suited to the harsh or rough operating conditions in an elevator shaft. The sensor devices and the micro-controller have a complete protection against contact and a protection against the ingress of dust and are furthermore protected against water spray. Furthermore, the said electrical components of the system are appropriately shielded from fluctuating external magnetic fields and from other influences of radiation due to mobile phones or radio devices. The housings of the respective components are appropriately insulated so that a surrounding temperature of e.g. −20° C. to +85° C. has no influence on a reliable functioning of the components.

In drive operation of the elevator car 6 the distance of the respective sensor devices 7 to 9 from the signal strip 1 is not constant because of oscillations, vibrations and the like occurring in the drive operation. The accuracy of the determination of the respective information forms of the signal strip 1 by the sensor devices is set such that a deviation of the sensor devices in the vertical direction (z-direction in FIG. 2 and FIG. 3) and in the horizontal direction (y-direction in FIG. 2 and FIG. 3) to the signal strip can vary by a few millimetres. As long as the distance of the respective sensor device to the signal strip 1 has a value in this range, the operating condition of the sensor device is normal. Only when the distance of a respective sensor device to the signal strip 1 becomes excessively big and lies outside of the above mentioned range, then the operation position of the sensor devices in relation to the signal strip is abnormal which is indicated by the sensor devices through an electrical signal with a parasitic frequency, as explained in more detail in the following.

The operational range of the three sensor devices 7 to 9 extends over different speed ranges, e.g. over a range from 0 m/s to 23 m/s. This range can be in turn divided into several sub-ranges, wherein the sensor devices only need to cover one working range respectively. Furthermore, oscillating movements of the respective sensor devices in a vertical direction are only permitted to lead to a frequency change in so far as this corresponds to the actual speed of the elevator car 6 or the sensor device relative to the signal strip 1. In particular, an oscillation around one and the same edge of a signal section of the signal strip 1 must not lead to a change in the frequency. Movements of the sensor devices in a horizontal direction within the operational range, in which a normal operation condition of the elevator car is ensured, must not cause any frequency change of course.

In drive operation of the car 6 the three sensor devices 7 to 9 are moved along the signal strip 1 with a certain speed. The respectively produced square wave signals are based on a change of the information of the signal strip in its alternating signal sections 2, 3. The output frequency of the square wave signal, which is output from the respective evaluation circuit of the sensor devices 7 to 9 is, according to the aforementioned equation, inversely or directly proportional to the speed of the car 6.

Through the system according to the invention, a position, a direction of movement and/or a speed of the car 6 can be determined accordingly. The signal strip 1 and the system according to the present invention can furthermore be a component of a device for speed limitation of the car 6, such a device comprising furthermore a brake device and/or a gripping device, which each act on the car. In such a device, the micro-controller of the system is electrically connected to the brake device and the gripping device and is designed such that for a determination of a speed of the car 6 which exceeds a first predetermined threshold value, a first electrical control signal V_{V} is output, whereby the brake device acting on the body is activated. For a determination of a speed of the elevator car 6 which exceeds a second predetermined value, the micro-controller outputs a second electrical control signal V_{A}, whereby the gripping device acting on the car is activated and the car is stopped instantly. In the structure diagram of FIG. 4, such a device 30 is shown in a principal schematic layout.

The device 30 comprises, apart from the signal strip 1 and the sensor devices 7 to 9, furthermore a micro-controller 10, a safety relay device connected thereto in the form of a first safety relay 11 and a second safety relay 12, a brake device (not shown), and an actuator 13 which is connected to the first safety relay 12 and which actuates a gripping device 14. In the left part of FIG. 4 the signal strip 1 and the three sensor devices 7 to 9 are shown, wherein the sensor devices 7 to 9 are attached to the elevator car and in drive operation of the elevator car are moved past the signal strip 1. Each of the sensor devices 7 to 9 comprises measuring elements (not shown) which are connected with the associated evaluation circuit of the sensor device. When passing by the signal strip 1, each of the sensor devices 7 to 9 produce electrical signals corresponding to the respective information forms of a signal section 2, 3, the electric signals being fed to the microcontroller 10. In a middle region of FIG. 4, the microcontroller 10 is shown, comprising a first channel A and a second channel B. The design of the micro-controller 10 is described in detail in the following. Furthermore (as shown in the right side of FIG. 4), an elevator controller 31 is provided which is separately connected to the microcontroller 10 and the first and second safety relays 11, 12 respectively.

The first safety relay 11 and the second safety relay 12 are connected to the first channel A and the second channel B respectively of the micro-controller 10. The first safety relay 11 is coupled to the actuator 13 which actuates and can trigger the gripping device 14. The second safety relay 12 acts on the brake device (not shown) and, with a corresponding control signal, can put the brake device into operation.

Device 30 shown by the structure diagram of FIG. 4 can be used, instead of a conventional mechanical safety system with an additional rope as previously explained, as a safety system e.g. for an elevator system in order to control or limit the speed of the car. The device 30 is characterised in relation to the known mechanical system by a higher reliability, it works silently also with high speeds of the elevator car, can be installed or retrofitted particularly in very high buildings without additional means and can finally be mounted easily in the elevator system. Because the otherwise necessary pulleys are not needed, and no separate installation space is required for the counterweight for the safety rope in a top area and at the bottom of the elevator shaft, the costs can be further reduced.

The micro-controller 10 contains, as previously explained, a first channel A and a second channel B. Each channel comprises three timer modules 15 to 17 to which are fed the electrical signals S1 to S3 of the respective sensor devices 7 to 9. For increasing the operational safety of the device, both these channels are provided with a different hardware, for example with two different processors. Each channel of the micro-controller 10 can comprise a RAM 21, a flash memory 22, an EEPROM 23, an OSC Watchdog 24, a CAN module and individual timer modules 15 to 17. The hardware system of the micro controller 10 is a standard electronic component, which can be obtained in industry, therefore the system and the internal computational process is not described in more detail in the following.

The electrical signals of the three sensor devices 7 to 9 are each respectively fed to the timer modules 15 to 17 of a respective channel A, B. An appropriate integration and calculation of the square wave signal fed to the timer module is then carried out, whereupon the actual speed of the car 6 can be determined. For a further increase in the operational safety, the first channel A and the second channel B are continuously compared to each other so that based on a comparison of the operands of the first channel A or the second channel B, differences in the electrical signals of the sensor devices 7 to 9 which e.g. are caused by faults are recognised as soon as possible.

The first safety relay 11 and the second safety relay 12 are operated, out of safety reasons, each with separate circuits. A plurality of safety relays can also be connected to each channel of the micro-controller 10, the plurality of safety relays being similarly operated with separate circuits, respectively. The respective safety relays 11, 12 are electrically connected with the individual channels A, B of the micro-controller 10 so that control signals from the channels A, B can be fed to the corresponding safety relays 11, 12 as will be later described, and so that in return a feedback from the safety relays 11, 12 can be sent to the micro-controller 10.

The second safety relay 12 is, as previously described, coupled to the actuator 13 which actuates the gripping device 14. A wedge device, known for decades, can be used for such a gripping device 14 which is driven between a guide rail of the elevator system and a side region of the car for stopping the car in an emergency. At a standstill of the car 6, the actuator can be activated and deactivated for test purposes through an electrical signal S_{A}. After finishing the test, the elevator system can be returned to normal drive operation.

In the following, the speed limitation using the device is described in detail referring to the mode of operation of the micro-controller 10.

In drive operation of the car 6, electrical signals S1 to S3 are fed to the timer modules 15 to 17 of the first channel A and the second channel B, respectively. In this connection, the electrical signal S1 designates a signal of the first sensor device 7, S2 an electrical signal of the second sensor device 8, and S3 an electrical signal of the third sensor device 9 correspondingly. On the basis of the signals S1 to S3 the actual speed of the elevator car 6 is determined in each channel A, B of the micro-controller. This actual speed is subsequently compared to an allowable predetermined target speed, whereupon further control signals are produced if necessary for controlling the brake device or the gripping device 14. In case the determined actual speed exceeds the predetermined target speed by a first predetermined threshold value, i.e. marginally, the first channel A and/or the second channel B produce a first electrical control signal V_{V} which is fed appropriately to the first safety relay 11. This causes an interruption of the circuit which operates the first safety relay 11, whereupon the brake device acting on the car 6 is triggered. The interaction of the brake device with the car results in a speed of the car 6 which is slightly to high being reduced back to the admissive target speed, or the car being braked if necessary.

In case the actual speed of the elevator car determined by the micro-controller 10 exceeds an allowable or admissive target speed by a second predetermined threshold value, i.e. by a considerable amount, a second electrical control signal V_{A} is produced by the first channel A and/or the second channel B and is fed accordingly to the second safety relay 12. Due to the coupling between the second safety relay 12 and the actuator 13, this leads to a triggering of the actuator, whereupon the gripping device 14 is actuated. The second electrical control signal V_{A} is produced in an emergency situation in which the determined speed of the elevator car 6 is too high, as explained. Consequently, the elevator car 6 is instantly stopped by the triggered gripping device 14.

The output signals of the sensor devices in the form of square wave signals (shown emblematically in the left side of FIG. 4), which are fed to the timer elements 15 to 17 of the micro-controller 10, are pulse waves having (corresponding to the aforementioned equation for inverse proportionality) a highest frequency at a speed of 0 and a sensor specific lowest frequency at a trigger speed (exceedance of the first or second threshold values) and a sensor specific highest frequency for a low speed of the car. As already explained above, the respective sensor devices give out an electrical signal with a parasitic frequency with the existence of an abnormal operation, e.g. with a faulty signal strip, whereupon the second electrical control signal signal V_{A} can also be produced.

After a triggering of the brake device by the first control signal V_{V} or the gripping device 14 by the second electrical control signal V_{A}, a subsequent operation of the device according to the invention is only possible after an operational check by a qualified person has taken place. After successful completion of the check, a suitable enabling signal S_{R}, 11 or S_{R}, 12 is sent from the corresponding safety relay 11 or 12 back to the corresponding channel A, B, whereupon a normal drive operation of the elevator system can be continued.

The device according to the invention enables three safety stages when monitoring the car speed. In the case e.g. that only one sensor device fails or an electrical signal with a parasitic frequency is sent to the micro-controller 10, then the car 6 is continued to be driven to a following floor, the car being stopped at this position for a further examination of the system by a qualified person. According to a further safety stage, the first electrical control signal V_{V} is produced for a slight excess speed of the car 6, whereby the brake device is activated to reduce the car speed. In a third safety stage, for a substantially excessive speed of the car 6, the gripping device 14 is actuated by the second electrical signal V_{A} with the actuator 13 and therefore stops the elevator car instantly.

The software of the micro-controller 10 is advantageously designed such that a failed reading or identification of the signal strip, e.g. following a development of smoke or excessive dirt, which leads to a corresponding electrical signal with a parasitic frequency, is not immediately interpreted as an emergency situation where the gripping device would usually be triggered. Instead, for an electrical signal with a parasitic frequency from only one of the three sensor devices, the normal drive operation of the car 6 is continued until the next floor and the elevator car is subsequently stopped at this position for a further examination. Such a stepwise designed safety architecture contributes substantially to the safety of transported passengers, because unnecessary emergency catch measures for the car, e.g. following a fouling of the signal strip, can be avoided.

The device can furthermore be designed such that, for an electrical signal with a parasitic frequency, a further electrical control signal is produced in the control device 10, which is fed to the elevator controller 31. The elevator controller 31 can subsequently, in consideration of further information regarding the movement state or the current position of the elevator car contained therein, make a decision whether or at which position the elevator car is to be stopped or braked. For this, the elevator controller 31 sends a corresponding signal to the first or second safety relay 11, 12 in order to interrupt their respective circuits. Additionally or alternatively to this, the elevator controller 31 can also produce a so-called service signal, whereby service personnel is informed of the existence of an abnormal operating condition.

The above described device ensures with the signal strip 1 and the optical and electrical components working together with it an effective speed limitation or speed control of the elevator car. The device can therefore replace conventional mechanical safety systems for limiting the speed of an elevator. Because no safety cable or the like must be entrained with the car, an important advantage of the invention lies in a low wear and silent operation together with higher possible final speeds of the car within a permissible range. The device satisfies, because of the above explained safety concept, the requirements of the elevator regulations and also the three safety stages of a four stage safety concept known in the state of the art.

The signal strip, the system and the device can, as previously explained, be similarly used in other applications where it concerns an effective monitoring and if necessary a limitation of the speed of a moving body.

1. A longitudinally extending signal strip, comprising a plurality of signal sections along its longitudinal extent, wherein at least every other signal section includes at least two different forms of information, each form of information based on a physical effect of its respective signal section and determinable by at least one sensor device.

2. Signal strip according to claim 1, wherein at least every other signal section contains at least three different forms of information.

3. Signal strip according to claim 1, wherein forms of information based on the same physical effect differ in adjacent signal sections.

4. Signal strip according to claim 1 further comprising identical forms of information based on a same physical effect in non-adjacent signal sections.

5. Signal strip according to claim 1, wherein a physical effect is based on radiation emitted by a respective signal section.

6. Signal strip according to claim 5, wherein the radiation produces at least one of an electrical field, a magnetic field and an electromagnetic field.

7. Signal strip according to claim 1, wherein at least one physical effect is based on a physical property of a respective signal section.

8. Signal strip according to claim 7, wherein the physical property of the respective signal section is one of an optical property, a magnetic property, a thermal conductivity, and a property relating to a reflection of electromagnetic waves.

9. Signal strip according to claim 1, wherein adjacent signal sections have different magnetic polarizations.

10. Signal strip according to claim 1, wherein adjacent signal sections are optically distinguishable.

11. Signal strip according to claim 1, wherein the signal strip includes a first signal section adjacent to a second signal section, the first signal section reflecting electromagnetic waves differently than the second signal section.

12. Signal strip according to claim 11, wherein the electromagnetic waves have a wave length in at least one of an ultrasonic range or a radar range.

13. Signal strip according to claim 11, wherein the first signal section is coated with a first material and the second signal section is coated with a second material, the first material reflecting electromagnetic waves differently than the second material.

14. Signal strip according to claim 1, wherein a first signal section and a second signal section are adjacent, the first signal section having at least one of a different thermal conductivity and a temperature that is different from a respective thermal conductivity and a respective temperature of the second signal section.

15. Signal strip according to claim 1, wherein the at least one sensor device is operable to determine forms of information of the signal sections without contacting the signal sections.

16. Signal strip according to claim 1, wherein the signal sections have an absolute coding.

17. Signal strip according to claim 1, wherein the signal strip has a first signal section and a second signal section having a same physical effect, the first signal section and the second signal section having about same width in a longitudinal direction of the signal strip.

18. Signal strip according to claim 1, further comprising a protective coating applied to a surface of the signal strip, wherein the protective coating is at least one of abrasion resistant, scratch proof and oil repelling.

19. System for determining movement of a body, comprising:
longitudinally extending signal strip, including a plurality of signal sections along its longitudinal extent, wherein at least every other signal section includes at least two different forms of information, each form of information based on a physical effect of its respective signal section;
at least two sensor devices for determining information from the signal strip each sensor device operable to create an electrical signal in accordance with the information determined by the sensor device.
control device in electrical communication with the sensor devices control device operable to determine at least one of a speed of the body, a direction of movement of the body and a current position of the body via the electrical signals created by the sensor devices,
wherein the sensor devices and the signal strip are disposed such that movement of the body causes relative movement of the sensor devices with respect to the signal strip's longitudinal extent.

20. System of claim 19, further comprising a sensor device corresponding to each physical effect of the signal strip, each sensor device utilizing a measuring compatible with the physical effect corresponding the sensor device.

21. System according to claim 19, wherein an electrical signal created by at least one of the sensor devices is a square wave signal.

22. System according to claim 21, wherein a frequency of the square wave signal is either directly proportional or inversely proportional to a relative speed between the signal strip and the at least one sensor device.

23. System according to claim 19, wherein at least one of the sensor devices creates an electrical signal with a parasitic frequency during an abnormal operating condition of the signal strip.

24. System according to claim 23, wherein the abnormal operating condition occurs at least if a distance between the at least one sensor device and the signal strip exceeds a predetermined threshold.

25. System according to claim 19, wherein at most one of the sensor devices utilizes an optical measuring method.

26. System according to claim 19, wherein the control device comprises a plurality of channels and the electrical signal created by each sensor device is fed each channels.

27. System according to claim 26, wherein each channels has at least one of independent hardware and independent software.

28. System according to claim 26, wherein the channels are continuously compared to each other.

29. System according to claim 19 further comprising a speed control subsystem for slowing the body.

30. System according to claim 29, further comprising at least one safety relay device is connected between the control device and the speed control subsystem.

31. System according to claim 30, wherein the at least one safety relay device comprises at least a first safety relay and a second safety relay.

32. System according to claim 31, wherein the first safety relay is operated by a first circuit and the second safety relay is operated by a second circuit, the first circuit independent of the second circuit.

33. System according to claim 31, wherein the control device comprises a plurality of channels, each channel in electrical communication with the first safety relay and the second safety relay.

34. System according to claim 29, wherein the speed control subsystem further comprises a gripping device for stopping the body and an actuator device for actuating the gripping device, the actuator device operable to actuate the gripping device upon receiving a second electrical control signal from the control device in response to a speed of the body exceeding a second predetermined threshold.

35. System according to claim 29, further comprising three sensor devices, the speed control subsystem further comprising a breaking device, wherein each sensor device is operable to create an electrical signal with a parasitic frequency during an abnormal operating condition of the sensor device, and the control device is operable to create a first electrical control signal in response to the control device receiving an electrical signal with a parasitic frequency from solely one sensor device, the first electrical control signal causing the brake device to stop the body at a predetermined position.

36. (canceled)

37. System according to claim 19, further comprising an elevator controller in communication with the body and the control device, the elevator controller operable to control a movement of the body in response to receiving a signal from the control device.

38. System according to one claim 29, wherein the speed control subsystem further comprises a gripping device for stopping the body, the system operable to actuate the gripping device if the control device receives electrical signals having parasitic frequencies from at least two sensor devices.

39-40. (canceled)

41. System according to claim 19 wherein the body is an elevator car.

42. System according to claim 19, wherein the sensor devices are attached to the body and the signal strip is attached to a stationary object.

43. System according to claim 19, wherein the signal strip is attached to the body and the sensor devices are attached to a stationary object.

44. System according to claim 43, wherein the signal strip is attached to a track of the body.

45. System according to claim 44, wherein a magnetic force holds the signal strip to the track of the body.

46. System of claim 19, wherein each sensor device includes:
a measuring element for determining information from the signal strip, and
an evaluation circuit for creating the electrical signal in accordance with the information determined by the measuring element.

47. System according to claim 29, wherein the speed control subsystem includes at least one of a breaking device for the slowing the body and a gripping device for stopping the body.

48. System according to claim 47, further comprising an actuator in communication with the gripping device, the actuator for actuating the gripping device.
